(19) United States
(12) Patent Application Publication
(10) Pub. No.: US 2007/0245422 A1
(43) Pub. Date: Oct. 18, 2007

(54) Phishing-Prevention Method Through Analysis of Internet Website to be Accessed and Storage Medium Storing Computer Program Source for Executing the Same

(75) Inventors: Tae Hyun Hwang, Seongnam-si (KR); Sung Hak Choi, Seoul (KR); Eui Jin Park, Seoul (KR)

Correspondence Address: GROSSMAN, TUCKER, PERREAULT & PFLEGER, PLLC, 55 SOUTH COMMERICAL STREET, MANCHESTER, NH, 03101, US

(73) Assignee: SOFTRUN, INC., Seoul (KR)

(21) Appl. No.: 11/550,182

(22) Filed: Oct. 17, 2006

(30) Foreign Application Priority Data
Apr. 18, 2006 (KR) 10-2006-0035125
Jul. 11, 2006 (KR) 10-2006-0065091

(51) Int. Cl. H04L 9/32

(52) U.S. Cl. 726/26

(57) ABSTRACT

There are provided a phishing-prevention method capable of preventing phishing-related accidents from which an Internet user suffers and storage medium storing a computer program source for executing the method. When a user attempts an access to a specific website through an e-mail and a web browser or inputs his/her own personal information directly in e-mail or the like to transmit the related information to outside, the website to be accessed or an Internet address of a specific server is analyzed in order to warn the user in advance so that the user can select whether to actually access thereto, prior to accessing to the website, if it is in danger. When the user attempts an access to a website similar to a famous or known website address, the method of the present invention warns the user of a possibility that will be a phishing website so that the user can select whether to actually access thereto. When the user makes use of the function of inputting his/her personal information directly in e-mail to transmit the related information directly to a specific server, the method of the present invention transfers a warning therefor to the user so that the user can select whether to actually transmit the related information. In making all the warnings and the user's selections, familiar and easily-expressed information associated with the website is provided to the user for his/her correct judgment.

### FIELD OF THE INVENTION

The present invention generally relates to a phishing-prevention method through analysis of Internet website to be accessed and storage medium storing a computer program source for executing the same. In particular, the present invention relates to a phishing-prevention method capable of preventing the drain of personal information of Internet user by precluding, based on the analysis of website to be accessed, phishing referring to fraudulent act that steals and illegally uses such information as an ID and a password of an individual, a credit card number and an available period thereof, account information, etc. from websites such as financial institutions' portal sites, game sites, public institutions' sites, etc., or by disguising with e-mails sent therefrom, and storage medium having a computer program source for executing the method.

### DESCRIPTION OF THE PRIOR ART

There are no methods or systems capable of preventing phishing known in the art. Therefore, phishing accidents often happen due to the use of ill-intentioned e-mails and websites, thereby leading to the drain of users' personal information and causing a monetary damage to the users.

### SUMMARY OF THE INVENTION

Therefore, a primary object of the present invention is to provide a phishing-prevention method capable of preventing phishing-related accidents from which an Internet user suffers and storage medium storing a computer program source for executing the method. This is accomplished by: if the user attempts an access to a specific website through an e-mail and a web browser or inputs his/her own personal information directly in e-mail or the like to transmit the related information to outside, analyzing the website to be accessed or an Internet address of a specific server to warn the user in advance prior to accessing the website if it is in danger so that the user can select whether to actually access thereto; if the user attempts an access to a website similar to a famous or known website address, warning the user of a possibility that it will be a phishing website so that the user can select whether to actually access thereto; and if the user makes use of the function of inputting his/her personal information directly in e-mail to transmit the related information directly to a specific server, warning the user of this so that the user can select whether to actually transmit the related information, wherein in making all the warnings and the user's selections, familiar and easily-expressed information associated with the website is forwarded to the user for his/her correct judgment.

To accomplish the above object of the present invention, there is provided a phishing-prevention method through analysis of Internet website to be accessed, the method comprising the steps of: (a) installing a phishing-prevention program for analyzing and judging in advance whether a website to which an Internet user wants to access is a phishing website, and warning the user if the judgment result is affirmative; (b) automatically downloading and registering the latest phishing website information and stable website information when the phishing-prevention program is driven by use of the Internet; (c) performing a comparison and an analysis of a website access address inputted by the Internet user and the registered phishing website information to judge whether or not the website access address is a phishing website address contained in the registered phishing website information; (d) conducting a comparison and an analysis of the website access address and the registered stable website information to judge whether or not the website access address is a phishing website address into which a stable website address involved in the stable website information is modified; (e) if the website access address is judged to be the phishing website address, providing the Internet user with a message window for providing website information or for showing a warning message prior to accessing to the website; and (f) allowing the Internet user to select one of an access cancellation, a movement to a website recommended, and an access to an initially access-desired website through the warning message window.

Herein, it is preferable that the website access address contains a website access address by a hyperlink of website and a hyperlink of e-mail.

Also, it is preferable that the phishing-prevention method further comprises the step of, if a website moved through the hyperlink of the website and the hyperlink of the e-mail is a stable website, showing a name of the website to the user in advance and confirming the result.

Furthermore, it is preferable that the phishing-prevention method further comprises the step of, in case of making an access to a website which is not registered in both the phishing website information and the stable website information through the hyperlink of the website and the hyperlink of the e-mail, showing the website to be accessed to the user in advance and confirming the result.

Moreover, it is preferable that the phishing-prevention method further comprises the step of making the information and warning message provided to the user not shown again by the user's setting.

Additionally, it is preferable that the phishing-prevention method further comprises the step of allowing the Internet access if the website access address inputted by the Internet user is the website address registered in the stable website information.

Further, it is preferable that the step (d) performs a comparison and an analysis on whether the inputted website access address is a website address in which alphabets of the stable website address are changed to numerals to thereby judge the inputted website access address as the phishing website address if the comparison and analysis results are affirmative.

Furthermore, it is preferable that the step (d) performs a comparison and an analysis on whether the inputted website access address is a website address in which an English character of the stable website address is changed to plural form to thereby judge the inputted website access address as the phishing website address if the comparison and analysis results are affirmative.

Moreover, it is preferable that the step (d) conducts a comparison and an analysis on whether the inputted website access address is a website address in which an English character of the stable website address is changed to gerund form to thereby judge the inputted website access address as the phishing website address if the comparison and analysis results are affirmative.

Also, it is preferable that the step (d) searches if there is an attempt of a direct access to an IP address, rather than the stable website address, to thereby judge the inputted website access address as the phishing website address if the search result is affirmative.

Also, it is preferable that the step (d) searches if there is an attempt of an access to an address including a host name in the stable website address to thereby judge the inputted website access address as the phishing website address if the search result is affirmative.

Additionally, it is preferable that the step (d) conducts a comparison and an analysis on whether the inputted website access address is a website address to which a consonant of the stable website address host name is changed, to thereby judge the inputted website access address as the phishing website address if the comparison and analysis results are affirmative.

Furthermore, it is preferable that the step (d) conducts a comparison and an analysis on whether the inputted website access address is a website address to which a vowel of the stable website address host name is changed, to thereby judge the inputted website access address as the phishing website address if the comparison and analysis results are affirmative.

Moreover, it is preferable that the step (d) conducts a comparison and an analysis on whether the inputted website access address is a website address to which an upper domain of the stable website address is changed to thereby judge the inputted website access address as the phishing website address if the comparison and analysis results are affirmative.

Also, it is preferable that the step (d) performs a comparison and an analysis on whether the inputted website access address is a website address to which a lower domain of the stable website address is changed to thereby judge the inputted website access address as the phishing website address if the comparison and analysis results are affirmative.

Also, it is preferable that the step (d) performs a comparison and an analysis on whether the inputted website access address is a website address in which a special character of the stable website address is additionally changed to thereby judge the inputted website access address as the phishing website address if the comparison and analysis results are affirmative.

Also, it is preferable that the step (d) conducts a comparison and an analysis on whether the inputted website access address is a website address in which one or more alphabet of the stable website address is overlapped to thereby judge the inputted website access address as the phishing website address if the comparison and analysis results are affirmative.

Also, it is preferable that the step (d) conducts a comparison and an analysis on whether the inputted website access address is a website address in which the stable website address involves a typographical error to thereby judge the inputted website access address as the phishing website address if the comparison and analysis results are affirmative.

Further, it is preferable that the step (d) conducts a comparison and an analysis on whether the inputted website access address is a website address having a specific keyword in URL to thereby judge the inputted website access address as the phishing website address if the comparison and analysis results are affirmative.

Additionally, it is preferable that the step (d) performs a comparison and an analysis on whether the inputted website access address is a website address having a specific keyword in second or more level domain of URL to thereby judge the inputted website access address as the phishing website address if the comparison and analysis results are affirmative.

Also, it is preferable that the step (d) searches if the inputted website access address has a specific keyword in a lower address of URL to thereby judge the inputted website access address as the phishing website address if the search result is affirmative.

Also, it is preferable that the step (d) searches if the inputted website access address has a port in URL to thereby judge the inputted website access address as the phishing website address if the search result is affirmative.

Also, it is preferable that the step (d) performs a comparison and an analysis on whether the inputted website access address is a website address in which a domain depth of URL exceeds 4 to thereby judge the inputted website access address as the phishing website address if the comparison and analysis results are affirmative.

Furthermore, it is preferable that the message window contains contents of a warning message, an item for selecting whether to add a website address that made an access attempt to a reliable website list, a website information provision link for moving to a website information page for more information on a website to be accessed and reliability confirmation and then searching the information, a link for canceling an access to a website, and a link for trying an access to a website.

In addition, in order to accomplish the above object of the present invention, there is provided a computer-readable storage medium storing a computer program source for executing any one of the phishing-prevention methods through analysis of Internet website to be accessed, as mentioned above.

The other objectives and advantages of the invention will be understood by the following description and will also be appreciated by the examples of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIGS. 1A and 1B are flowcharts illustrating a phishing-prevention method through analysis of Internet website to be accessed according to a preferred embodiment of the present invention;

FIGS. 2A and 2B are flowcharts exemplifying a phishing-prevention method through analysis of Internet website to be accessed according to another preferred embodiment of the present invention;

FIGS. 3A and 3B are flowcharts describing a method for judging whether a website address inputted by a user or an address to be accessed is a phishing website address according to the present invention;

FIG. 4 illustrates a web screen showing a warning message window for recommending confirmation of a website to a user and also for selecting whether to actually access to the website;

FIG. 5 is a web screen showing, in case where a user inputs his/her personal information directly in e-mail or the like and then sends the same to a specific server, a warning message window for the user to select whether to actually transmit the information; and

FIG. 6 is a web screen showing, when a user makes website access and sends personal information to outside, familiar and easily-expressed information to the user so that he/she can correctly judge whether to continue the above action.

### DETAILED DESCRIPTION OF THE INVENTION

Hereinafter, preferred embodiments of the present invention will be described in detail with reference to the accompanying drawings. The following embodiments are provided as illustrations of the present invention merely, and therefore, it should not be interpreted to limit the scope of the present invention by these embodiments.

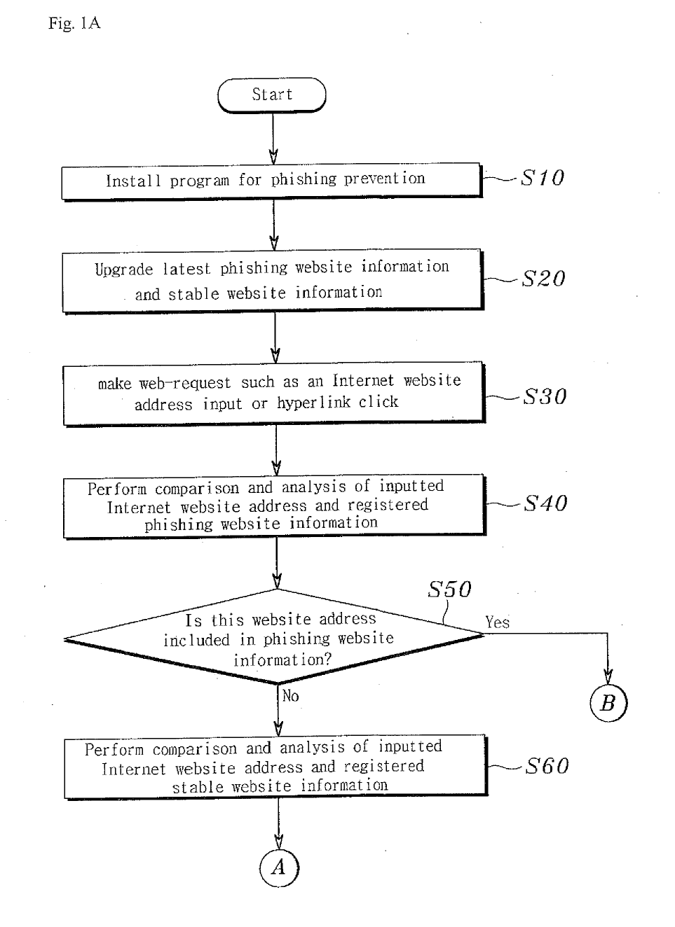

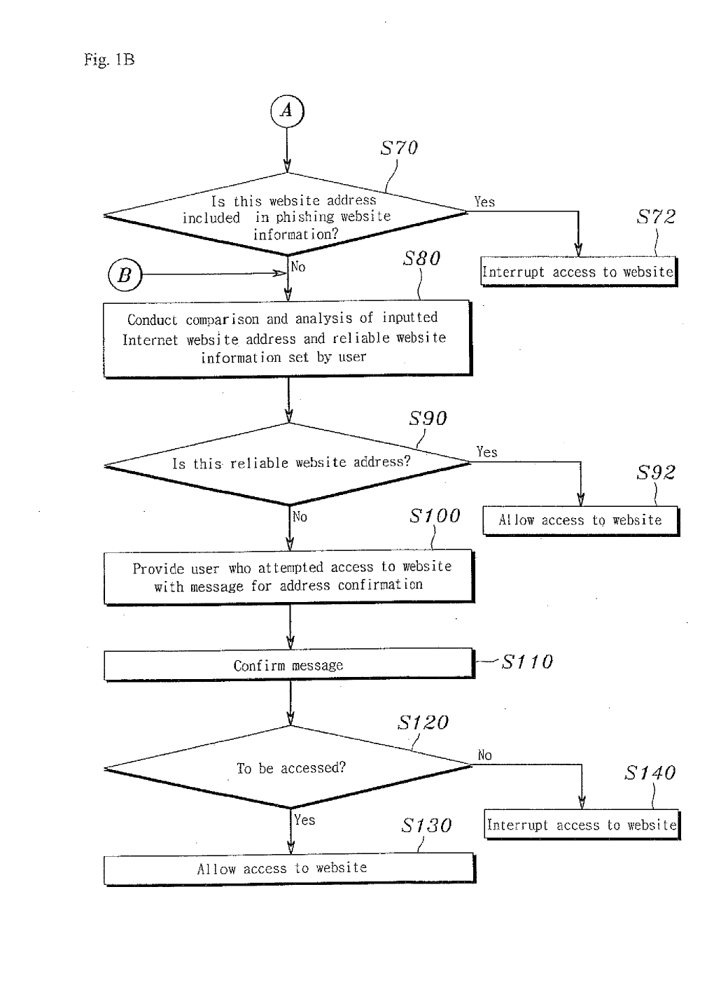

FIGS. 1A and 1B are flowcharts illustrating a phishing-prevention method through analysis of Internet website to be accessed according to a preferred embodiment of the present invention, which show a case where an Internet user attempts an access by inputting an address of a website to be accessed.

First of all, as shown in FIG. 1, the phishing-prevention method through analysis of Internet website to be accessed according to the present invention installs a phishing-prevention program for analyzing and judging in advance whether a website to which an Internet user wants to access is a phishing website, and then warning to the user if so (S10).

At this time, a PC in which the phishing-prevention program has been installed automatically downloads and upgrades the latest phishing website information and stable website information whenever the user makes an access to Internet (S20). These latest phishing website information and stable website information are stored in a database (DB), respectively.

Next, a web request such as an Internet website address input or hyperlink click is made by the Internet user (S30).

Thereafter, an engine (not shown) for judging whether the inputted website address is a phishing website address is driven, wherein the inputted website address and registered phishing website information are compared and analyzed (S40).

As the comparison and analysis results, if the website address inputted by the Internet user is a website address contained in the phishing website information (“Yes” in step S50), the process of the present invention proceeds to step S80 to be described later via tap B; but, if it is not any website address in the phishing website information (“No” in step S50), the process goes to step S60.

And then, a comparison and an analysis of the inputted website address and registered stable website information are performed (S60). After that; it is judged whether or not the website address inputted by the Internet user is a phishing website address into which a website address included in the stable website information is modified (S70).

If the user-inputted website address is the phishing website address into which the website address in the stable website information is modified (“Yes” in step S70), the process interrupts an access to the inputted website address (S72). But, if it is not the phishing website address into which the website address in the stable website information is modified (“No” in step S70), the process goes to a next step (S80)

Subsequently, the user-inputted website address and reliable website information set by the Internet user are compared and analyzed (S80), wherein it is judged whether or not the user-inputted website address is a website address involved in the reliable website information set by the user (S90).

At this time, if the user-inputted website address is the reliable website address set by the Internet user (“Yes” in step S90), the process allows an access to the inputted Internet website address (S92). But, if it is not the reliable website address set by the user (“No” in step S90), the process provides the user who attempted the access to the website with a message window for address confirmation (step S100). The message window serves to provide a warning message or wait for such access until completion of user's confirmation for access to a desired website, without allowing an immediate access when accessing to a phishing website or a well-unknown website.

In succession, the Internet user confirms the message window provided on a web screen (S110), and then selects whether to access to the inputted website address (“Yes” in step S120 and S130) or to interrupt the access (“No” in step S120 and S140).

At this time, the Internet user may register the inputted website address in the reliable website information when he/she convinces it of a website that is not a phishing website, thereby making it impossible to accept such message window having information and warning message.

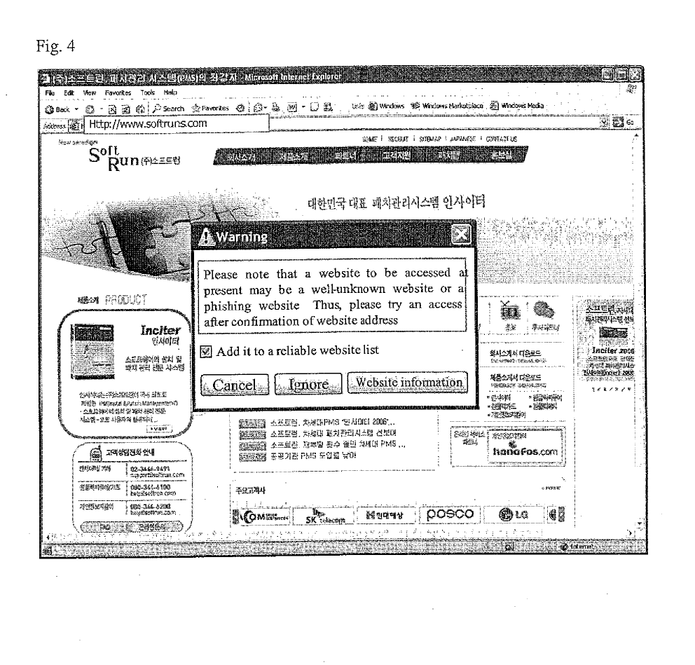

The message window displayed on the web screen contains the website information and warning message, as depicted in FIG. 4. The website information of the message window provides information on phishing website and information associated therewith, and is used to exchange information related to stable websites and unstable websites between users.

It can be set by the user that the message window outputted on the web screen is not provided thereon again.

The following is an illustrative description of the phishing website address to which the website address contained in the stable website information is changed.

Assuming that there is a phishing website of an original website named as “Http://www.softrun.com,” its address can be found as follows.

(1) A phishing website in which an alphabet “O“ is changed to Arabic numeral

(Ex) “Http://www.SOFTRUN.com”

(2) A case of attempting an access to an address in which English character is changed to plural form

(Ex) “Http://www.softruns.com”

(3) A case of attempting an access to an address in which English character is changed to gerund form

(Ex) “Http://www.softrunning.com”

(4) A case of attempting a direct access to an IP address rather than URL

(Ex) “Http://192.168.1.111”

(5) A case of attempting an access to an address having a host name in a detailed address

(Ex) “Http:/softrun.com/index.htm”

(6) A case of attempting an access to URL in which a consonant of a host name is changed based on a host name of a website address known as a stable one

(Ex) “Http://www.soffrun.com”

(7) A case of attempting an access to URL in which a vowel of a host name is changed based on a host name of a website address known as a stable one

(Ex) “Http://www.softrvn.com”

(8) A case of attempting an access to an address in which an upper domain is changed

(Ex) “Http://www2.softrun.com”

(9) A case of attempting an access to an address in which a lower domain is changed

(Ex) “Http://www.softrun.ne”

(10) A case of attempting an access to a changed address to which a special character is added

(Ex) “Http://www.soft-run.com”

(11) A case of attempting an access to an address that involves a typographical error

(Ex) “Http://www.softrum.com”

(12) A case of attempting an access to an address in which a path of visible website hyperlink is different from that of actually accessed hyperlink

(Ex) Attempt an access to “Http://www.abcde.com” actually while showing a link as “Http://www.softrum.com”

(13) A case of having a specific keyword in URL

(Ex) “Http://www.softrum.com/KEYWORD”

(14) A case of having a specific keyword in second or more level domain of URL

(Ex) “Http://KEYWORD.www.softrum.com”

(15) A case of having a specific keyword in a lower address of URL

(Ex) “Http://www.softrum.com/board/index/default_KEYWORD.html”

(16) A case of having a port in URL

(Ex) “Http://www.softrum.com:1234”

(17) A case where a domain depth of URL exceeds 4

(Ex) “Http://abc.www.best.softrum.com”

In the above-described way, the phishing website can be detected, and the warning messages recommending confirmation of related websites can be provided to the Internet user.

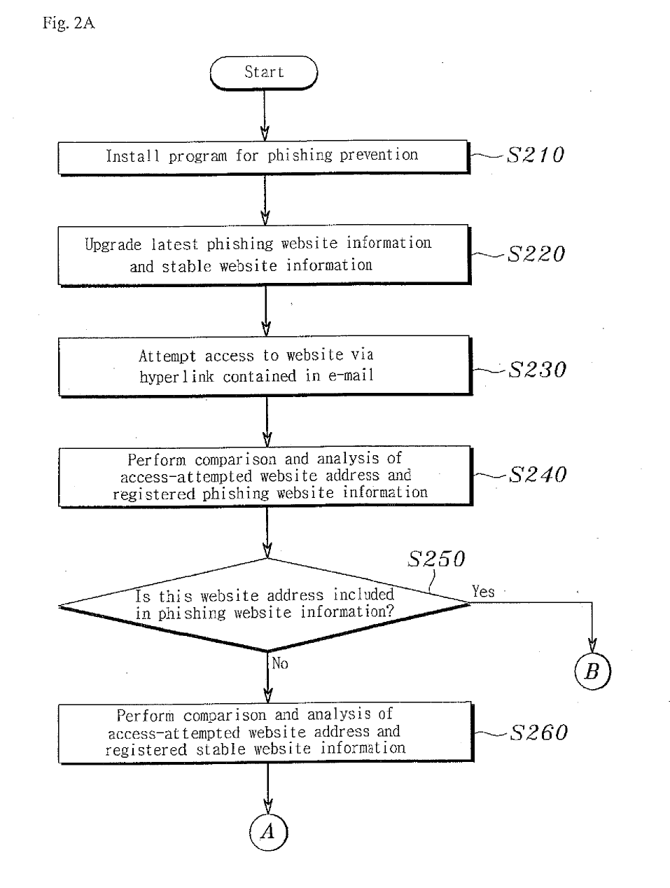

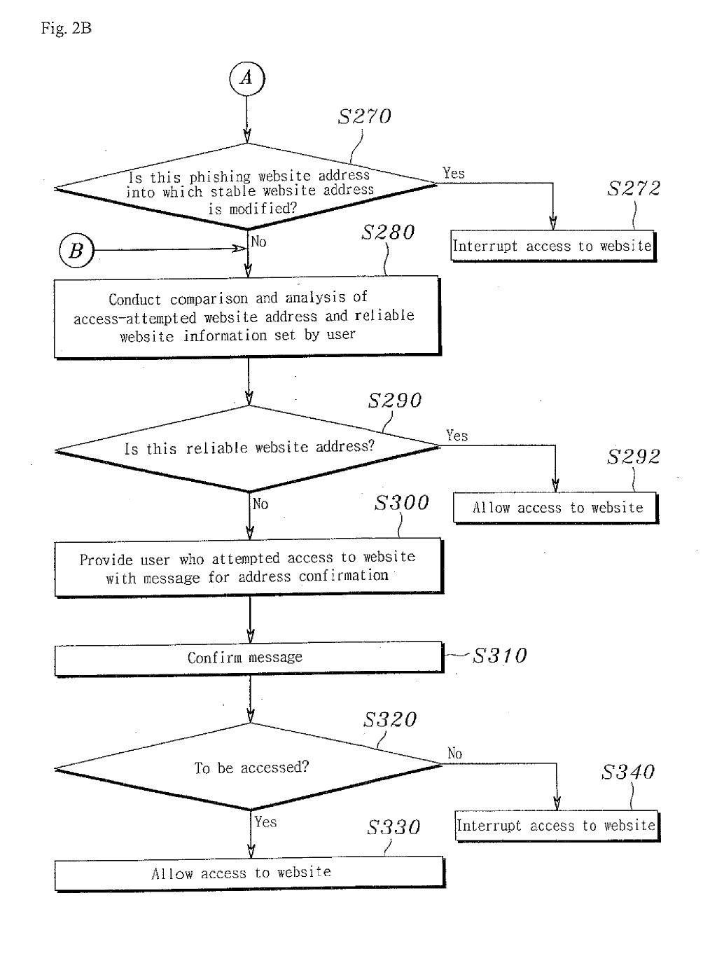

FIGS. 2A and 2B are flowcharts exemplifying a phishing-prevention method through analysis of Internet website to be accessed according to another preferred embodiment of the present invention, which represents a case where a user attempts an access to the website via a hyperlink of e-mail.

The phishing-prevention method through analysis of Internet website to be accessed via a hyperlink of e-mail will be explained in detail with reference to FIG. 2.

First of all, as in FIG. 1, a phishing-prevention program is installed in a user's PC, wherein it is analyzed and judged in advance whether a website to be accessed is a phishing website and then warned to the Internet user if so (S210).

At this time, the PC in which the phishing-prevention program has been installed automatically downloads and upgrades the latest phishing website information and stable website information whenever the user makes an access to Internet (S220). These latest phishing website information and stable website information are stored in a DB, respectively.

Next, when the Internet user attempts an access to a website through a hyperlink contained in e-mail (S230), an engine (not shown) for judging whether the access-attempted Internet website address is a phishing website address is driven, wherein the access-attempted website address and registered phishing website information are compared and analyzed (S240).

At this time, if the access-attempted website address is a website address contained in the phishing website information (“Yes” in step S250), the process of the present invention proceeds to step S280 to be explained later via tap B. But, if it is not a website address in the phishing website information (“No” in step S250), the process goes to step S260.

And then, the access-attempted website address and registered stable website information are compared and analyzed (S260) in order to judge whether the access-attempted website address is a phishing website address into which the website address included in the stable website information is modified (S270). At this time, the method of judging whether the access-attempted website address is the phishing website address into which the stable website address is modified is conducted in the same way as that described in FIG. 1.

Thereafter, if the access-attempted website address is the phishing website address into which the stable website address is modified (“Yes” in step S270), the process interrupts an access to the access-attempted website address (S272). But, if it is not the phishing website address into which the stable website address is modified (“No” in step S270), the process progresses to a next step (S280).

After that, a comparison and an analysis are done on the access-attempted website address and reliable website information set by the Internet user (S280), wherein it is judged whether or not the access-attempted website address is a website address contained in the reliable website information set by the user (S290).

At this time, if the access-attempted website address is the reliable website address set by the user (“Yes” in step S290), the process allows the access to the access-attempted website address (S292); but, if it is not the reliable website address set by the user (“No” in step S290), the process provides the user who attempted such website access with a message window for address confirmation (S300). Herein, the message window serves to provide a warning message or wait for such website access until completion of user's confirmation for access to a desired website, without allowing an immediate access when accessing to a phishing website or a well-unknown website.

Subsequently, the Internet user confirms the message window displayed on the web screen (S310), and selects whether to access to the inputted website address (“Yes” in step S320 and S330) or to interrupt the access (“No” in step S320 and S340).

At this time, the Internet user may register the access-attempted website address in the reliable website information when he/she convinces it of a website that is not a phishing website, thereby making it impossible to receive such message window having information and warning message.

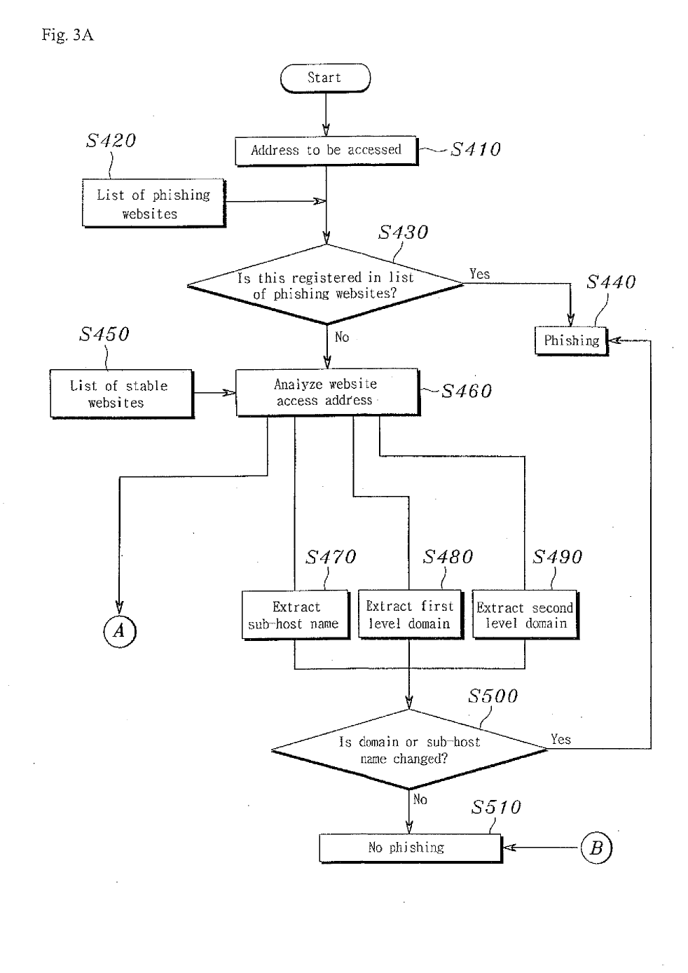

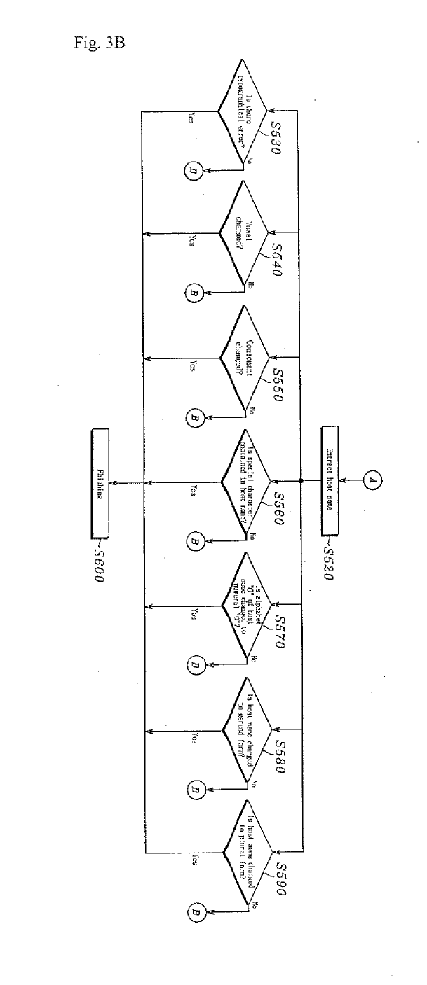

FIGS. 3A and 3B are flowcharts describing a method for judging whether a website address inputted by a user or an address to be accessed is a phishing website address according to the present invention.

First of all, the process of the present invention performs a comparison and an analysis of the user-inputted website address or an address to be accessed and information of a list of preregistered phishing websites in order to judge whether the website access address is registered in the phishing website list or not (S410 to S430).

If the website access address is registered in the phishing website list (“Yes” in step S430), the process judges the website access address as the phishing website address (S440). But, if the website access address is not registered in the phishing website list (“No” in step S430), the process goes to a following step S460.

The process compares the website access address with information of a list of preregistered stable websites in order to analyze the website access address (S460).

In the above step S460, the process extracts each of a sub-host name and first and second level domains of website access address inputted by the Internet user (address to be accessed) to judge whether a domain or sub-host name is changed or not (S470 to S500). At this time, if the domain or sub-host name is changed (“Yes” in step S500), the process judges the website access address as the phishing website address (S440). But, if the domain or sub-host name is not changed (“No” in step S500), the process judges that the website access address is not the phishing website address (S510).

Meanwhile, the process extracts a host name in the analysis (S460) of the website access address (S520) and then judges the website access address as the phishing website address if the host name involves a typographical error (“Yes” in step S530), its vowel is changed (“Yes” in step S540), its consonant is changed (“Yes” in step S550), it has a special character and changed (“Yes” in step S560), its alphabet “O” is changed to Arabic numeral “0” (“Yes” in step S570), it is changed to gerund form (“Yes” in step S580), or it is changed to plural form(“Yes” in step S590). Otherwise, i.e., if the host name is not under any of the above cases, the process judges that the website access address is not the phishing website address (S510).

FIG. 4 illustrates a web screen showing a warning message window for recommending confirmation of a website to a user and also for selecting whether to actually access to the website.

The warning message window includes a warning message indicating that “a website to be accessed at present may be a well-unknown website or a phishing website, and thus, please try an access after confirmation of a website address,” as shown in FIG. 4. In addition, it further contains an item for selecting whether to add the currently access-attempted website address to a reliable website list, a website information provision link for moving to a website information page and then searching required information in order to confirm more information and reliability of the website to be accessed, a “cancel” link for canceling an access to a website, an “ignore” link for trying an access to a website, and the like.

It may be possible for the user to arbitrarily register stable websites to be frequently accessed through the warning message window so as to display the warning message only once.

According to the present invention, the links or message contents provided on the warning message window can be varied or added.

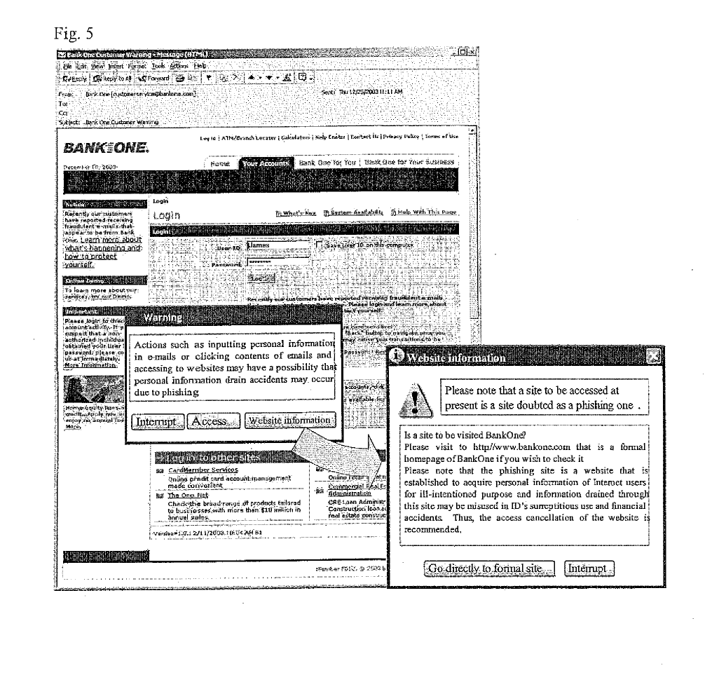

FIG. 5 is a web screen showing, in case where a user inputs his/her personal information directly in e-mail or the like and then sends the same to a specific server, a warning message window for the user to select whether to actually transmit the information.

As shown in FIG. 5, in case where the user inputs his/her personal information directly in e-mail or the like and then sends the same to a specific server, a warning message window is displayed for the user to select whether to actually transmit the information. At this time, the “phishing warning” message window may include a warning message such as “please note that such actions as inputting personal information in e-mails or clicking contents of e-mails and accessing to websites have a possibility that personal information drain accidents may occur due to phishing. Also, it may include an interruption link, an access link, a website information link and the like. At this time, if the website information link is selected, a website information message window as shown in FIG. 5 is provided. The website information message window may include a “go directly to a formal site” link and an “interruption” link, together with the message as follows. For example, the message may be “A site to be accessed at present is a site doubted as a phishing one. Is a site to be visited BankOne? Please visit to http://www.bankone.com that is a formal homepage of BankOne if you wish to check it. Please note that the phishing site is a website that is established to acquire personal information of Internet users for ill-intentioned purpose and information drained through this site may be misused in ID's surreptitious use and financial accidents. Thus, the access cancellation of the website is recommended.”

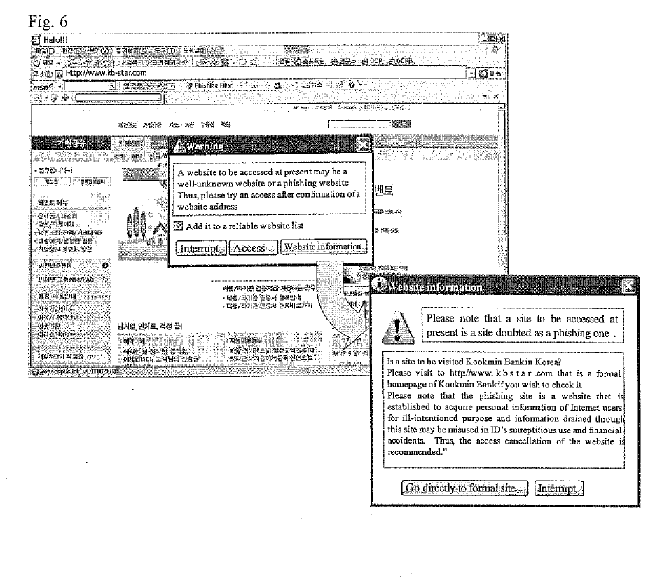

FIG. 6 is a web screen showing, when the user makes website access and sends personal information to outside, familiar and easily-expressed information provided to the user so that he/she can correctly judge whether to continue the above action.

As shown in FIG. 6, when the user makes website access and sends personal information to outside, a warning message window is provided in the form of familiar and easily-expressed information to the user so that he/she can correctly judge whether to continue the above action. At this time, the “phishing warning” message window may include a warning message indicating that “A website to be accessed at present may be a well-unknown website or a phishing website. Thus, please try an access after confirmation of a website address,” and also includes an interruption link, an access link, a website information link and the like. At this time, if the website information link is selected, a website information message window as shown in FIG. 6 is outputted. The website information message window may include a “go directly to a formal site” link and an “interruption” link, together with the message as follows. In other words, the message may be, for example, “A site to be accessed is a site doubted as a phishing one. Is a site to be visited Kookmin Bank in Korea? Please visit to http://www.kbstar.com that is a formal homepage of Kookmin Bank if you wish to check it. Please note that the phishing site is a website that is established to acquire personal information of Internet users for ill-intentioned purpose and information drained through this site may be misused in ID's surreptitious use and financial accidents. Thus, the access cancellation of the website is recommended.”

As described above, according to the phishing-prevention method through analysis of Internet website to be accessed and storage medium having a computer program source for executing the same of the present invention, phishing accidents that may happen due to phishing transferred via e-mails and spam mails, an unstable link of website, and an input error of website address can be precluded, so that the drain of user's personal information and lots of Internet accidents including financial accidents caused by the information drain can be prevented.

While the present invention has been shown and described with respect to particular embodiments, it will be apparent to those skilled in the art that many changes and modifications may be made without departing from the spirit and scope of the invention as defined in the appended claims.

What is claimed is:

1. A phishing-prevention method through analysis of Internet website to be accessed, the method comprising the steps of:
(a) installing a phishing-prevention program for analyzing and judging in advance whether a website to which an Internet user wants to access is a phishing website, and warning the user if the judgment result is affirmative;
(b) automatically downloading and registering the latest phishing website information and stable website information when the phishing-prevention program is driven by use of said Internet;
(c) performing a comparison and an analysis of a website access address inputted by the Internet user and the registered phishing website information to judge whether or not the website access address is a phishing website address contained in the registered phishing website information;
(d) conducting a comparison and an analysis of the website access address and the registered stable website information to judge whether or not the website access address is a phishing website address into which a stable website address contained in the stable website information is modified;
(e) if the website access address is judged to be the phishing website address, providing the Internet user with a message window for providing website information or for showing a warning message prior to accessing to the website; and
(f) allowing the Internet user to select one of an access cancellation, a movement to a website recommended, and an access to an initially access-desired website through the warning message window.

2. The method of claim 1, wherein the website access address contains a website access address by a hyperlink of website and a hyperlink of e-mail.

3. The method of claim 2, further comprising the step of, if a website moved through the hyperlink of the website and the hyperlink of the e-mail is a stable website, showing a name of the website to the user in advance and confirming the result.

4. The method of claim 1, further comprising the step of, in case of making an access to a website which is not registered in both the phishing website information and the stable website information through the hyperlink of the website and the hyperlink of the e-mail, showing the website to be accessed to the user in advance and confirming the result.

5. The method of claim 1, further comprising the step of making the information and warning message provided to the user not shown again by the user's setting.

6. The method of claim 1, further comprising the step of allowing the Internet access if the website access address inputted by the Internet user is the website address registered in the stable website information.

7. The method of claim 1, wherein said step (d) performs a comparison and an analysis on whether the inputted website access address is a website address in which alphabets of the stable website address are changed to numerals to thereby judge the inputted website access address as the phishing website address if the comparison and analysis results are affirmative.

8. The method of claim 1, wherein said step (d) performs a comparison and an analysis on whether the inputted website access address is a website address in which an English character of the stable website address is changed to plural form to thereby judge the inputted website access address as the phishing website address if the comparison and analysis results are affirmative.

9. The method of claim 1, wherein said step (d) conducts a comparison and an analysis on whether the inputted website access address is a website address in which an English character of the stable website address is changed to gerund form to thereby judge the inputted website access address as the phishing website address if the comparison and analysis results are affirmative.

10. The method of claim 1, wherein said step (d) searches if there is an attempt of a direct access to an IP address, rather than the stable website address, to thereby judge the inputted website access address as the phishing website address if the search result is affirmative.

11. The method of claim 1, wherein said step (d) searches if there is an attempt of an access to an address including a host name in the stable website address, to thereby judge the inputted website access address as the phishing website address if the search result is affirmative.

12. The method of claim 1, wherein said step (d) conducts a comparison and an analysis on whether the inputted website access address is a website address to which a consonant of the stable website address is changed, to thereby judge the inputted website access address as the phishing website address if the comparison and analysis results are affirmative.

13. The method of claim 1, wherein said step (d) conducts a comparison and an analysis on whether the inputted website access address is a website address to which a vowel of the stable website address is changed, to thereby judge the inputted website access address as the phishing website address if the comparison and analysis results are affirmative.

14. The method of claim 1, wherein said step (d) conducts a comparison and an analysis on whether the inputted website access address is a website address to which an upper domain of the stable website address is changed to thereby judge the inputted website access address as the phishing website address if the comparison and analysis results are affirmative.

15. The method of claim 1, wherein said step (d) performs a comparison and an analysis on whether the inputted website access address is a website address to which a lower domain of the stable website address is changed to thereby judge the inputted website access address as the phishing website address if the comparison and analysis results are affirmative.

16. The method of claim 1, wherein said step (d) performs a comparison and an analysis on whether the inputted website access address is a website address to which a special character of the stable website address is additionally changed to thereby judge the inputted website access address as the phishing website address if the comparison and analysis results are affirmative.

17. The method of claim 1, wherein said step (d) conducts a comparison and an analysis on whether the inputted website access address is a website address in which one or more alphabet of the stable web site address is overlapped to thereby judge the inputted website access address as the phishing website address if the comparison and analysis results are affirmative.

18. The method of claim 1, wherein said step (d) conducts a comparison and an analysis on whether the inputted website access address is a website address in which the stable website address involves a typographical error to thereby judge the inputted website access address as the phishing website address if the comparison and analysis results are affirmative.

19. The method of claim 1, wherein said step (d) conducts a comparison and an analysis on whether the inputted website access address is a website address having a specific keyword in URL to thereby judge the inputted website access address as the phishing website address if the comparison and analysis results are affirmative.

20. The method of claim 1, wherein said step (d) performs a comparison and an analysis on whether the inputted website access address is a website address having a specific keyword in second or more level domain of URL to thereby judge the inputted website access address as the phishing website address if the comparison and analysis results are affirmative.

21. The method of claim 1, wherein said step (d) searches if the inputted website access address has a specific keyword in a lower address of URL to thereby judge the inputted website access address as the phishing website address if the search result is affirmative.

22. The method of claim 1, wherein said step (d) searches if the inputted website access address has a port in URL to thereby judge the inputted website access address as the phishing website address if the search result is affirmative.

23. The method of claim 1, wherein said step (d) performs a comparison and an analysis on whether the inputted website access address is a website address in which a domain depth of URL exceeds 4 to thereby judge the inputted website access address as the phishing website address if the comparison and analysis results are affirmative.

24. The method of claim 1, wherein the message window contains contents of a warning message, an item for selecting whether to add a website address that made an access attempt to a reliable website list, a website information provision link for moving to a website information page for more information on a website to be accessed and reliability confirmation and then searching the information, a link for canceling an access to a website, and a link for trying an access to a website.

25. A computer-readable storage medium storing a computer program source for executing the phishing-prevention method through analysis of Internet website to be accessed of any one of claims 1 to 24.
